(19) United States
(12) Patent Application Publication
(10) Pub. No.: US 2006/0107858 A1
(43) Pub. Date: May 25, 2006

(54) Heat-sensitive lithographic printing plate precursor

(76) Inventors: Marc Van Damme, Mortsel (BE); Peter Hendrikx, Mortsel (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/544,923

(22) PCT Filed: Feb. 4, 2004
(86) PCT No.: PCT/EP04/50080

§ 371 Date: Dec. 8, 2005

Related U.S. Application Data
(60) Provisional application No. 60/450,612, filed on Feb. 27, 2003.

(30) Foreign Application Priority Data
Feb. 11, 2003 (EP) 03100280.1

(51) Int. Cl. B41N 1/00

(52) U.S. Cl. 101/453

(57) ABSTRACT

A heat-sensitive lithographic printing plate precursor is disclosed which comprises a hydrophilic support and a coating provided thereon, wherein the coating comprises an infrared absorbing dye and is optimised for producing a minimum extent of ablation when exposed to high power infrared laser light.

### FIELD OF THE INVENTION

The present invention relates to a heat-sensitive lithographic printing plate precursor which requires alkaline processing.

### BACKGROUND OF THE INVENTION

Lithographic printing typically involves the use of a so-called printing master such as a printing plate which is mounted on a cylinder of a rotary printing press. The master carries a lithographic image on its surface and a print is obtained by applying ink to said image and then transferring the ink from the master onto a receiver material, which is typically paper. In conventional lithographic printing, ink as well as an aqueous fountain solution (also called dampening liquid) are supplied to the lithographic image which consists of oleophilic (or hydrophobic, i.e. ink-accepting, water-repelling) areas as well as hydrophilic (or oleophobic, i.e. water-accepting, ink-repelling) areas. In so-called driographic printing, the lithographic image consists of ink-accepting and ink-adhesive (ink-repelling) areas and during driographic printing, only ink is supplied to the master. Printing masters are generally obtained by the so-called computer-to-film method wherein various pre-press steps such as typeface selection, scanning, color separation, screening, trapping, layout and imposition are accomplished digitally and each color selection is transferred to a graphic arts film using an image setter. After processing, the film can be used as a master.

A typical photosensitive printing plate precursor for computer-to-film methods comprises a hydrophilic support and an image-recording layer which includes UV-sensitive compositions. Upon image-wise exposure of a negative-working plate, typically by means of a film mask in a UV contact frame, the exposed image areas become insoluble and the unexposed areas remain soluble in an aqueous alkaline developer. The plate is then processed with the developer to remove the diazonium salt or diazo resin in the unexposed areas. So the exposed areas define the image areas (printing areas) of the printing master, and such printing plate precursors are therefore called ‘negative working’. Also positive working materials, wherein the exposed areas define the non-printing areas, are known, e.g. plates having a novolac/naphtoquinone-diazide coating which dissolves in the developer only at exposed areas.

In addition to the above photosensitive materials, also heat-sensitive printing plate precursors have become very popular. Such thermal materials offer the advantage of daylight stability and are especially used in the so-called computer-to-plate method wherein the plate precursor is directly exposed, i.e. without the use of a film mask. Usually the material is image-wise exposed to heat or to infrared light and the generated heat triggers a (physico-)chemical process, such as ablation, polymerization, insolubilization by cross-linking of a polymer or by particle coagulation of a thermoplastic polymer latex, and solubilization by the destruction of intermolecular interactions or by increasing the penetrability of a development barrier layer.

EP 1 188 797 discloses a near-infrared absorbing material comprising a novel polymethine compound which shows a high sensitivity to a YAG laser having an emission wavelength of 900 nm to 1100 nm, and a printing plate utilizing said near-infrared absorbing material.

EP 1 096 315 discloses a negative-working printing plate precursor including a support and a photosensitive layer containing an infrared absorber, an onium salt, a radical polymerizing compound and a binder. The absorbance of said photosensitive layer varies between 0.5 and 1.2.

EP 1 129 845 discloses a heat-mode printing plate comprising a on a hydrophilic support a photosensitive layer comprising an infrared absorber, a polymerization initiator and a compound having a polymerizable unsaturated group in a solvent, wherein the residual solvent in the photosensitive layer is 5% wt or less relative to the weight of the photosensitive layer.

Thermal plates which require no processing are also known; such plates are typically of the so-called ablative type, i.e. the differentiation between hydrophilic and oleophilic areas is produced by heat-induced ablation of one or more layers of the coating, so that at exposed areas a surface is revealed which has a different affinity towards ink or fountain than the surface of the unexposed coating. A major problem associated with ablative plates, however, is the generation of ablation debris which may contaminate the electronics and optics of the exposure device and which needs to be removed from the plate by wiping it with a cleaning solvent, so that ablative plates are often not truly processless. Ablation debris which is deposited onto the plate's surface may also interfere during the printing process.

Thermal plates are generally exposed to infrared light in a plate-setter, which can be of the internal drum (ITD), external drum (XTD) or flatbed type. The availability of low-cost, high-power infrared laser diodes enables to manufacture plate-setters wherein thermal plate materials can be exposed at a higher drum rotation speed, resulting in a shorter total exposure time and a higher plate throughput. The high power infrared laser diodes are able to provide a high power density (kW/cm²) at the plate surface resulting in the necessary amount of energy (J/cm²) in a shorter pixel dwell time. It is observed that such a high power exposure of so-called non-ablative thermal plates, i.e. plates which are not designed to form an image by ablation, nevertheless produces partial ablation of the coating. This phenomenon is to be avoided in view of the problems associated with the generation of ablation debris as discussed above.

### SUMMARY OF THE INVENTION

It is an aspect of the present invention to provide a thermal lithographic printing plate precursor wherein the coating is optimised for producing a minimum extent of ablation when exposed to high power infrared laser light. This object is realized by the material of claim 1. Specific embodiments of the invention are defined in the dependent claims.

According to the method of the present invention, as defined in claim 12, the printing plate precursor can be exposed to laser light having a wavelength in the range of λmax±20 nm and a power density above 233 kW/cm² without generation of ablation debris.

### BRIEF DESCRIPTION OF THE DRAWINGS

FIG. 1 shows the infrared absorption spectrum of a comparative material (dotted line) and a material according to the present invention (solid line).

FIG. 2-6 are scanning electron microscopy (SEM) images of the coating of a prior art material exposed to infrared laser light at various power density values.

### DETAILED DESCRIPTION OF THE INVENTION

The heat-sensitive lithographic printing plate precursor of the present invention contains a hydrophilic support and a coating provided thereon comprising an infrared light absorbing dye and a hydrophobic binder which is soluble in an aqueous alkaline developer. The coating may consist of one or more layer(s). Examples of additional layers besides the layer(s) which comprise the hydrophobic binder or the layer(s) which comprise the infrared dye are discussed below.

The formation of the lithographic image by the printing plate precursor of the present invention is due to a heat-induced solubility differential of the coating during processing in the developer. The solubility differentiation between image (printing, oleophilic) and non-image (non-printing, hydrophilic) areas of the lithographic image is characterized by a kinetic rather than a thermodynamic effect, i.e. the non-image areas are characterized by a faster dissolution in the developer than the image-areas. In a most preferred embodiment, the non-image areas of the coating dissolve completely in the developer before the image areas are attacked so that the latter are characterized by sharp edges and high ink-acceptance. The time difference between completion of the dissolution of the non-image areas and the onset of the dissolution of the image areas is preferably longer than 10 seconds, more preferably longer than 20 seconds and most preferably longer than 60 seconds, thereby offering a wide development latitude.

The printing plate precursor is positive-working when after exposure by heat or infrared light and development the exposed areas of the coating are removed from the support due to a higher dissolution rate in the aqueous alkaline developer than the unexposed areas and define hydrophilic (non-printing) areas, whereas the unexposed coating is not removed from the support and defines an oleophilic (printing) area. For a negative working printing plate precursor, after image wise exposure by heat or infrared light the is exposed image areas dissolve slower in an aqueous alkaline developer than the unexposed areas which remain soluble. For the latter plate precursor the exposed areas define the image areas or printing areas. The printing plate precursor of the present invention can be positive- or negative-working with the positive working embodiment being preferred.

The support of the lithographic printing plate precursor has a hydrophilic surface or is provided with a hydrophilic layer. The support may be a sheet-like material such as a plate or it may be a cylindrical element such as a sleeve which can be slid around a print cylinder of a printing press. The support is a metal support such as aluminum or stainless steel. The metal can also be laminated to a plastic layer, e.g. polyester film.

A particularly preferred lithographic support is an electrochemically grained and anodized aluminum support. Graining and anodization of aluminum is well known in the art. The anodized aluminum support may be treated to improve the hydrophilic properties of its surface. For example, the aluminum support may be silicated by treating its surface with a sodium silicate solution at elevated temperature, e.g. 95° C. Alternatively, a phosphate treatment may be applied which involves treating the aluminum oxide surface with a phosphate solution that may further contain an inorganic fluoride. Further, the aluminum oxide surface may be rinsed with a citric acid or citrate solution. This treatment may be carried out at room temperature or may be carried out at a slightly elevated temperature of about 30 to 50° C. A further interesting treatment involves rinsing the aluminum oxide surface with a s bicarbonate solution. Still further, the aluminum oxide surface may be treated with polyvinylphosphonic acid, polyvinylmethylphosphonic acid, phosphoric acid esters of polyvinyl alcohol, polyvinylsulfonic acid, polyvinylbenzenesulfonic acid, sulfuric acid esters of polyvinyl alcohol, and acetals of polyvinyl alcohols formed by reaction with a sulfonated aliphatic aldehyde. It is further evident that one or more of these post treatments may be carried out alone or in combination. More detailed descriptions of these treatments are given in GB-A-1 084 070, DE-A-4 423 140, DE-A-4 417 907, EP-A-659 909, EP-A-537 633, DE-A-4 001 466, EP-A-292 801, EP-A-291 760 and U.S. Pat. No. 4,458,005.

The hydrophobic binder can be present in one or more layer(s) of the coating. It is preferably an organic polymer which has acidic groups with a pKa of less than 13 to ensure that the layer is soluble or at least swellable in aqueous alkaline developers. Advantageously, the binder is a polymer or polycondensate, for example a polyester, polyamide, polyurethane or polyurea. Polycondensates and polymers having free phenolic hydroxyl groups, as obtained, for example, by reacting phenol, resorcinol, a cresol, a xylenol or a trimethylphenol with aldehydes, especially formaldehyde, or ketones are also particularly suitable. Condensates of sulfamoyl- or carbamoyl-substituted aromatics and aldehydes or ketones are also suitable. Polymers of bismethylol-substituted ureas, vinyl ethers, vinyl alcohols, vinyl acetals or vinylamides and polymers of phenylacrylates and copolymers of hydroxyl-phenylmaleimides are likewise suitable. Furthermore, polymers having units of vinylaromatics, N-aryl(meth)acrylamides or aryl (meth)acrylates may be mentioned, it being possible for each of these units also to have one or more carboxyl groups, phenolic hydroxyl groups, sulfamoyl groups or carbamoyl groups. Specific examples include polymers having units of 2-hydroxyphenyl (meth)acrylate, of N-(4-hydroxyphenyl)(meth)acrylamide, of N-(4-sulfamoylphenyl)-(meth)acrylamide, of N-(4-hydroxy-3,5-dimethylbenzyl)-(meth)acrylamide, or 4-hydroxystyrene or of hydroxyphenylmaleimide. The polymers may additionally contain units of other monomers which have no acidic units. Such units include vinylaromatics, methyl(meth)acrylate, phenyl(meth)acrylate, benzyl(meth)acrylate, methacrylamide or acrylonitrile.

Any amount of binder can be used. The amount of the binder is advantageously from 40 to 99.8% by weight, preferably from 70 to 99.4% by weight, particularly preferably from 80 to 99% by weight, based in each case on the total weight of the nonvolatile components of the coating. In a preferred embodiment, the polycondensate is a phenolic resin, such as a novolac, a resole or a polyvinylphenol. The novolac is preferably a cresol/formaldehyde or a cresol/xylenol/formaldehyde novolac, the amount of novolac advantageously being at least 50% by weight, preferably at least 80% by weight, based in is each case on the total weight of all binders. Additional suitable polymeric binders are described in EP-02102443, EP-02102444, EP-02102445, EP-02102446, filed on 15/10/2002, DE-A-4007428, DE-A-4027301 and DE-A-4445820.

A suitable negative-working alkaline developing printing plate comprises a phenolic resin and a latent Brönsted acid which produces acid upon heating or IR radiation. These acids catalyze crosslinking of the coating in a post-exposure heating step and thus hardening of the exposed regions. Accordingly, the non-exposed regions can be washed away by a developer to reveal the hydrophilic substrate underneath. For a more detailed description of such a negative-working printing plate precursor we refer to U.S. Pat. No. 6,255,042 and U.S. Pat. No. 6,063,544 and to references cited in these documents.

In a preferred embodiment the lithographic printing plate precursor of the present invention is positive working and contains a hydrophilic support and a coating provided thereon comprising an infrared light absorbing dye and a hydrophobic binder which is soluble in an aqueous alkaline developer.

In the positive working embodiment, the dissolution behavior of the coating in the developer can be fine-tuned by optional solubility regulating components. More particularly, development accelerators and development inhibitors can be used. These ingredients can be added to the layer(s) which comprise(s) the hydrophobic binder and/or to (an)other layer(s) of the coating.

Development accelerators are compounds which act as dissolution promoters because they are capable of increasing the dissolution rate of the coating. For example, cyclic acid anhydrides, phenols or organic acids can be used in order to improve the aqueous developability. Examples of the cyclic acid anhydride include phthalic anhydride, tetrahydrophthalic anhydride, hexahydrophthalic anhydride, 3,6-endoxy-4-tetrahydro-phthalic anhydride, tetrachlorophthalic anhydride, maleic anhydride, chloromaleic anhydride, alpha -phenylmaleic anhydride, succinic anhydride, and pyromellitic anhydride, as described in U.S. Pat. No. 4,115,128. Examples of the phenols include bisphenol A, p-nitrophenol, p-ethoxyphenol, 2,4,4′-trihydroxybenzophenone, 2,3,4-trihydroxy-benzophenone, 4-hydroxybenzophenone, 4,4′,4″-trihydroxy-triphenylmethane, and 4,4′,3″,4″-tetrahydroxy-3,5,3′,5′-tetramethyltriphenyl-methane, and the like. Examples of the organic acids include sulfonic acids, sulfonic acids, alkylsulfuric acids, phosphonic acids, phosphates, and carboxylic acids, as described in, for example, JP-A 60-88,942 and JP-A 2-96,755. Specific examples of these organic acids include p-toluenesulfonic acid, dodecylbenzenesulfonic acid, p-toluenesulfonic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, 3,4,5-trimethoxybenzoic acid, 3,4,5-trimethoxycinnamic acid, phthalic acid, terephthalic acid, 4-cyclohexene-1,2-dicarboxylic acid, erucic acid, lauric acid, n-undecanoic acid, and ascorbic acid. The amount of the cyclic acid anhydride, phenol, or organic acid contained in the coating is preferably in the range of 0.05 to 20% by weight.

In a preferred embodiment, the coating also contains developer resistance means, also called development inhibitors, i.e. one or more ingredients which are capable of delaying the dissolution of the unexposed areas during processing. The dissolution inhibiting effect is preferably reversed by heating, so that the dissolution of the exposed areas is not substantially delayed and a large dissolution differential between exposed and unexposed areas can thereby be obtained. Such developer resistance means can be added to a layer comprising the hydrophobic binder or to another layer of the material.

The compounds described in e.g. EP-A 823 327 and WO97/39894 act as dissolution inhibitors due to interaction, e.g. by hydrogen bridge formation, with the alkali-soluble binder(s) in the coating. Inhibitors of this type typically comprise a hydrogen bridge forming group such as nitrogen atoms, onium groups, carbonyl (—CO—), sulfinyl (—SO—) or sulfonyl (—SO₂—) groups and a large hydrophobic moiety such as one or more aromatic groups.

Other suitable inhibitors improve the developer resistance because they delay the penetration of the aqueous alkaline developer into the coating. Such compounds can be present in the layer(s) comprising the hydrophobic binder, as described in e.g. EP-A 950 518, and/or in a development barrier layer on top of said layer, as described in e.g. EP-A 864 420, EP-A 950 517, WO 99/21725 and WO 01/45958. In the latter embodiment, the solubility of the barrier layer in the developer or the penetrability of the barrier layer by the developer can be increased by exposure to heat or infrared light.

Preferred examples of inhibitors which delay the penetration of the aqueous alkaline developer into the coating include :
(a) A polymeric material which is insoluble in or impenetrable by the developer, e.g. a hydrophobic (co-)polymer such as acrylic polymers, polystyrene, styrene-acrylic copolymers, polyesters, polyamides, polyureas, polyurethanes, nitrocellulosics and epoxy resins; or water-repellent polymers such as polymers comprising siloxane (silicones) and/or perfluoroalkyl units. The water-repellent polymer may be present in an amount of e.g. between 0.5 and 15 mg/m², preferably between 0.5 and 10 mg/m², more preferably between 0.5 and 5 mg/m² and most preferably between 0.5 and 2 mg/m² Higher or lower amounts are also suitable, depending on the hydrophobic/oleophobic character of the compound. When the water-repellent polymer is also ink-repelling, higher amounts than 15 mg/m² can result in poor ink-acceptance of the non-exposed areas. An amount lower than 0.5 mg/m² on the other hand may lead to an unsatisfactory development latitude: development of the exposed areas is not completed.
(b) Bifunctional compounds such as surfactants comprising a polar group and a hydrophobic group such as a long chain hydrocarbon group, a poly- or oligosiloxane and/or a perfluorinated hydrocarbon group. A typical example is Megafac F-177, a perfluorinated surfactant available from Dainippon Ink & Chemicals, Inc. A suitable amount of such compounds is between 10 and 100 mg/m², more preferably between 50 and 90 mg/m².
(c) Bifunctional block-copolymers comprising a polar block such as a poly- or oligocalkylene oxide) and a hydrophobic block such as a long chain hydrocarbon group, a poly- or oligosiloxane and/or a perfluorinated hydrocarbon group. A suitable amount of such compounds is between 0.5 and 25 mg/m², preferably between 0.5 and 15 mg/m² and most preferably between 0.5 and 10 mg/m². A suitable copolymer comprises about 15 to 25 siloxane units and 50 to 70 alkyleneoxide groups. Preferred examples include copolymers comprising phenylmethylsiloxane and/or dimethylsiloxane as well as ethylene oxide and/or propylene oxide, such as Tego Glide 410, Tego Wet 265, Tego Protect 5001 or Silikophen P50/X, all commercially available from Tego Chemie, Essen, Germany. Specific compounds are the following: 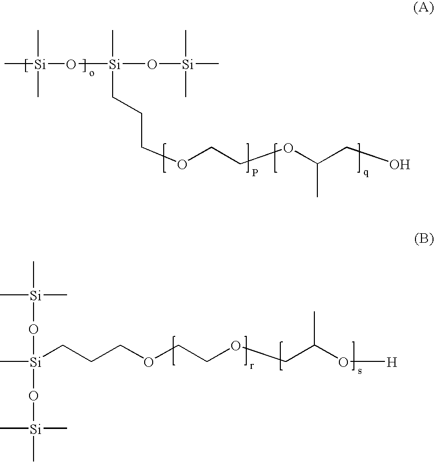
   wherein o, p, q, r and s are integers >1.

In formula A, a poly(alkylene oxide) block consisting of ethylene oxide and propylene oxide units is grafted to a polysiloxane block. In formula B, long chain alcohols consisting of ethylene oxide and propylene oxide units are grafted to a trisiloxane group.

The above mentioned poly- or oligosiloxane groups can be a linear, cyclic or complex cross-linked polymer or copolymer. The term polysiloxane shall include any compound which contains more than one siloxane group —Si(R,R′)—O—, wherein R and R′ are optionally substituted alkyl or aryl groups. Preferred siloxanes are phenylalkylsiloxanes and dialkylsiloxanes. The number of siloxane groups in the polymer or oligomer is at least 2, preferably at least 10, more preferably at least 20. It may be less than 100, preferably less than 60. The above mentioned perfluorinated hydrocarbon group includes e.g. —(CF₂)— units. The number of such units may be larger than 10, preferably larger than 20. The poly- or oligo(alkylene oxide) block preferably includes units of the formula —CₙH₂ₙ—O— wherein n is preferably an integer in the range 2 to 5. The moiety —CₙH₂ₙ— may include straight or branched chains. The alkylene moiety may also comprise optional substituents. Preferred embodiments and explicit examples of such polymers have been disclosed in WO99/21725.

During coating and drying, the above mentioned inhibitor of type (b) and (c) tends to position itself, due to its bifunctional structure, at the interface between the coating and air and thereby forms a separate top layer even when applied as an ingredient of the coating solution of the layer comprising the hydrophilic binder. Simultaneously, the surfactants or bifunctional block-copolymers act as spreading agents which improve the coating quality. The separate top layer thus formed is capable of acting as the above mentioned barrier layer which delays the penetration of the developer into the coating.

Alternatively, the inhibitor of type (a) to (c) can be applied in a separate solution, coated on top of the layer(s) comprising the hydrophobic binder. In that embodiment, it may be advantageous to use a solvent in the second coating solution that is not capable of dissolving the ingredients present in the first layer so that a highly concentrated water-repellent or hydrophobic phase is obtained at the top of the material which is capable of acting as the above mentioned development barrier layer.

In the printing plate precursor of the present invention, the infrared light absorbing dye may be present in the same layer(s) as the hydrophobic binder, in the optional barrier layer discussed above and/or in an optional other layer. According to a highly preferred embodiment, the dye is concentrated in or near the barrier layer, e.g. in an intermediate layer between the hydrophobic binder and the barrier layer. According to that embodiment, said intermediate layer comprises the IR absorbing compound in an amount higher than the amount of IR absorbing compound in the hydrophobic binder or in the barrier layer. Preferred IR absorbing dyes are cyanine dyes, merocyanine dyes, indoaniline dyes, oxonol dyes, pyrilium dyes and squarilium dyes. Examples of suitable IR dyes are described in e.g. EP-A 823327, EP-A 978376, EP-A 1029667, EP-A 1053868, EP-A 1093934; WO 97/39894 and WO 00/29214. A preferred compound is the following cyanine dye:

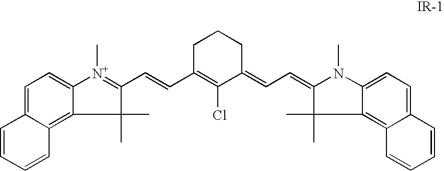

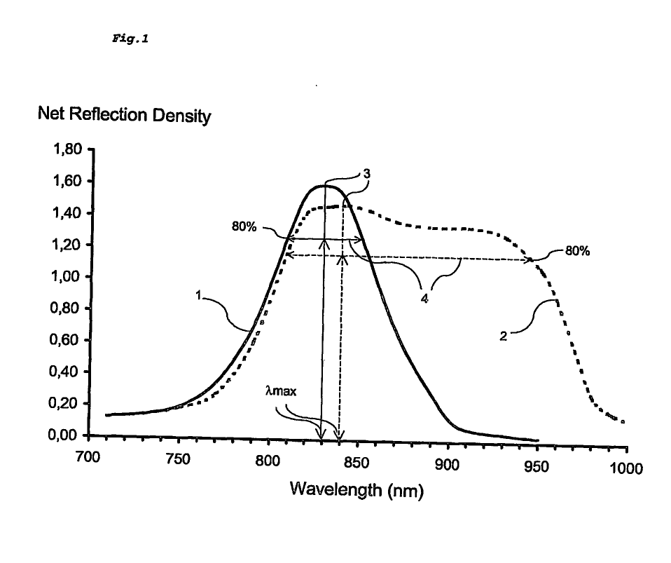

The absoption spectra of the net reflection density versus wavelength (FIG. 1) of the coatings of this invention have been measured. The absorption maxima λmax (3) of the spectra are situated in the range from 700 nm to 1000 nm, more specific in the range from 700 nm to 890 nm, most specific in the range from 700 nm to 850 nm. It has been found that the compositions of this invention (FIG. 1, solid line 1), which have a band width (4) measured at 80% of the net reflection density at λmax lower than 1000 cm⁻¹, show no partial ablation after infrared exposure. The comparative compositions (FIG. 1, dotted line 2) having a band width (4) broader than 1000 cm⁻¹ show ablative side reactions after infrared exposure. Whilst the applicants do not wish to be limited by any theoretical explanation of how their printing plate precursor operates, it is believed that in the comparative compositions aggregates of the infrared light absorbing dye are formed which tend to form hot spots in the coating leading to unwanted partial ablation.

To protect the surface of the coating, in particular from mechanical damage, a protective layer may also optionally be applied. The protective layer generally comprises at least one water-soluble polymeric binder, such as polyvinyl alcohol, polyvinylpyrrolidone, partially hydrolyzed polyvinyl acetates, gelatin, carbohydrates or hydroxyethylcellulose, and can be produced in any known manner such as from an aqueous solution or dispersion which may, if required, contain small amounts, i.e. less than 5% by weight, based on the total weight of the coating solvents for the protective layer, of organic solvents. The thickness of the protective layer can suitably be any amount, advantageously up to 5.0 μm, preferably from 0.1 to 3.0 μm, particularly preferably from 0.15 to 1.0 μm.

Optionally, the coating and more specifically the layer(s) comprising the hydrophobic binder may further contain additional ingredients. Preferred ingredients are e.g. additional binders, especially sulfonamide and phthalimide groups containing polymers, to improve the run length and chemical resistance of the plate. Examples of such polymers are those described in EP-A 933682, EP-A 894622 and WO 99/63407.

Also colorants can be added such as dyes or pigments which provide a visible colour to the coating and which remain in the coating at unexposed areas so that a visible image is produced after exposure and processing. Typical examples of such contrast dyes are the amino-substituted tri- or diarylmethane dyes, e.g. crystal violet, methyl violet, victoria pure blue, flexoblau 630, basonylblau 640, auramine and malachite green. Also the dyes which are discussed in depth in the detailed description of EP-A 400706 are suitable as contrast dyes for use in the printing plate precursor of the present invention.

Surfactants, especially perfluoro surfactants, silicon or titanium dioxide particles, polymers particles such as matting agents and spacers are also well-known components of lithographic coatings which can be used in the plate precursor of the present invention.

For the preparation of the lithographic plate precursor, any known method can be used. For example, the above ingredients can be dissolved in a solvent mixture which does not react irreversibly with the ingredients and which is preferably tailored to the intended coating method, the layer thickness, the composition of the layer and the drying conditions. Suitable solvents include ketones, such as methyl ethyl ketone (butanone), as well as chlorinated hydrocarbons, such as trichloroethylene or 1,1,1-trichloroethane, alcohols, such as methanol, ethanol or propanol, ethers, such as tetrahydrofuran, glycol-monoalkyl ethers, such as ethylene glycol monoalkyl ether, e.g. 2-methoxy-1-propanol, or propylene glycol monoalkyl ether and esters, such as butyl acetate or propylene glycol monoalkyl ether acetate. It is also possible to use a mixture which, for special purposes, may additionally contain solvents such as acetonitrile, dioxane, dimethylacetamide, dimethylsulfoxide or water.

Any coating method can be used for applying one or more coating solutions to the hydrophilic surface of the support. A multi-layer coating can be applied by coating/drying each layer consecutively or by the simultaneous coating of several coating solutions at once. In the drying step, the volatile solvents are removed from the coating until the coating is self-supporting and dry to the touch. However it is not necessary (and may not even be possible) to remove all the solvent in the drying step. Indeed the residual solvent content may be regarded as an additional composition variable by means of which the composition may be optimised. Drying is typically carried out by blowing hot air onto the coating, typically at a temperature of at least 70° C., suitably 80-150° C. and especially 90-140° C. Also infrared lamps can be used. The drying time may typically be 15-600 seconds.

The material can be image-wise exposed directly with heat, e.g. by means of a thermal head, or indirectly by infrared light, preferably near infrared light. The infrared light is preferably converted into heat by an IR light absorbing compound as discussed above. The heat-sensitive lithographic printing plate precursor of the present invention is preferably not sensitive to visible light, i.e. no substantial effect on the dissolution rate of the coating in the developer is induced by exposure to visible light. Most preferably, the coating is not sensitive to ambient daylight, i.e. visible (400-750 nm) and near UV light (300-400 nm) at an intensity and exposure time corresponding to normal working conditions so that the material can be handled without the need for a safe light environment. “Not sensitive” to daylight shall mean that no substantial change of the dissolution rate of the coating in the developer is induced by exposure to ambient daylight. In a preferred daylight stable embodiment, the coating does not comprise photosensitive ingredients, such as (quinone)diazide or diazo(nium) compounds, photoacids, photoinitiators, sensitizers etc., which absorb the near UV and/or visible light that is present in sun light or office lighting and thereby change the solubility of the coating in exposed areas.

The printing plate precursor of the present invention can be exposed to light, e.g. by means of LEDs or a laser head. Preferably, one or more lasers or a laser diode are used. The light used for the exposure is infrared light having a wavelength in the range of λmax±20 nm, more specific in the range of λmax±10 nm; most specific in the range of λmax±5 nm. Preferably a laser such as a semiconductor laser diode is used. The required laser power depends on the sensitivity of the image-recording layer, the pixel dwell time of the laser beam, which is determined by the spot diameter (typical value of modern plate-setters at 1/e² of maximum intensity: 10-25 μm), the scan speed and the resolution of the exposure apparatus (i.e. the number of addressable pixels per unit of linear distance, often expressed in dots per inch or dpi; typical value: 1000-4000 dpi).

Two types of laser-exposure apparatuses are commonly used: internal (ITD) and external drum (XTD) plate-setters. ITD plate-setters for thermal plates are typically characterized by a very high scan speed up to 1500 m/sec and may require a laser power of several Watts. The Agfa Galileo T (trademark of Agfa Gevaert N.V.) is a typical example of a plate-setter using the ITD-technology. XTD plate-setters operate at a lower scan speed typically from 0.1 m/sec to 20 m/sec and have a typical laser-output-power per beam from 20 mW up to 500 mW. The Creo Trendsetter plate-setter family (trademark of Creo) and the Agfa Excalibur plate-setter family (trademark of Agfa Gevaert N.V.) both make use of the XTD-technology. The known plate-setters can be used as an off-press exposure apparatus, which offers the benefit of reduced press down-time. XTD plate-setter configurations can also be used for on-press exposure, offering the benefit of immediate registration in a multi-color press. More technical details of on-press exposure apparatuses are described in e.g. U.S. Pat. No. 5,174,205 and U.S. Pat. No. 5,163,368. In the development step, the non-image areas of the coating are removed by immersion in a conventional aqueous alkaline developer, which may be combined with mechanical rubbing, e.g. by a rotating brush. During development, any water-soluble protective layer present is also removed. Silicate-based developers which have a ratio of silicon dioxide to alkali metal oxide of at least 1 are preferred to ensure that the alumina layer (if present) of the substrate is not damaged. Preferred alkali metal oxides include Na₂O and K₂O, and mixtures thereof. In addition to alkali metal silicates, the developer may optionally contain further components, such as buffer substances, complexing agents, antifoams, organic solvents in small amounts, corrosion inhibitors, dyes, surfactants and/or hydrotropic agents as well known in the art. The development is preferably carried out at temperatures from 20 to 40° C. in automated processing units as customary in the art. For regeneration, alkali metal silicate solutions having alkali metal contents of from 0.6 to 2.0 mol/l can suitably be used. These solutions may have the same silica/alkali metal oxide ratio as the developer (generally, however, it is lower) and likewise optionally contain further additives. The required amounts of regenerated material must be tailored to the developing apparatuses used, daily plate throughputs, image areas, etc. and are in general from 1 to 100 ml per square meter of recording material. The addition can be regulated, for example, by measuring the conductivity as described in EP-A 0 556 690.

The plate precursor according to the invention can, if required, then be post-treated with a suitable correcting agent or preservative as known in the art. To increase the resistance of the finished printing plate and hence to extend the print run, the layer can be briefly heated to elevated temperatures (“baking”). As a result, the resistance of the printing plate to washout agents, correction agents and UV-curable printing inks also increases. Such a thermal post-treatment is described, inter alia, in DE-A 14 47 963 and GB-A 1 154 749.

Besides the mentioned post-treatment, the processing of the plate precursor may also comprise a rinsing step, a drying step and/or a gumming step.

The printing plate thus obtained can be used for conventional, so-called wet offset printing, in which ink and an aqueous dampening liquid is supplied to the plate. Another suitable printing method uses so-called single-fluid ink without a dampening liquid. Single-fluid inks which are suitable for use in the method of the present invention have been described in U.S. Pat. No. 4,045,232; U.S. Pat. No. 4,981,517 and U.S. Pat. No. 6,140,392. In a most preferred embodiment, the single-fluid ink comprises an ink phase, also called the hydrophobic or oleophilic phase, and a polyol phase as described in WO 00/32705.

### EXAMPLES

Preparation of the Lithographic Support

A 0.30 mm thick aluminum foil was degreased by immersing the foil in an aqueous solution containing 5 g/l of sodium hydroxide at 50° C. and rinsed with demineralized water. The foil was then electrochemically grained using an alternating current in an aqueous solution containing 4 g/l of hydrochloric acid, 4 g/l of hydroboric acid and 5 g/l of aluminum ions at a temperature of 35° C. and a current density of 1200 A/m² to form a surface topography with an average center-line roughness Ra of 0.5 μm. After rinsing with demineralized water, the aluminum foil was then etched with an aqueous solution containing 300 g/l of sulfuric acid at 60° C. for 180 seconds and rinsed with demineralized water at 25° C. for 30 seconds. The foil was subsequently subjected to anodic oxidation in an aqueous solution containing 200 g/l of sulfuric acid at a temperature of 45° C., a voltage of 10V at a current density of 150 A/m² during 300 seconds to form an anodic oxidation film of 3 g/m² of Al₂O₃, then washed with demineralized water, post-treated with a solution containing 4 g/l polyvinylphosphonic acid and subsequently with an aluminium trichloride solution. Finally, the foil was rinsed with demineralized water at 20° C. and dried.

The printing plate precursors of the Examples 1-5 (invention) and Examples 6-7 (comparative) were produced by coating the solutions defined in Table 1 onto the above described lithographic support. The coating solutions were applied at a wet coating thickness of 26 μm on a coating line operating at a speed of 10.8 m/min and then dried at 135° C.

TABLE 1
composition of the coating solutions

| Ingredients (g) | Ex. 1 (inv.) | Ex. 2 (inv.) | Ex. 3 (inv.) | Ex. 4 (inv.) | Ex. 5 (inv.) | Ex. 6 (comp.) | Ex. 7 (comp.) |
|---|---|---|---|---|---|---|---|
| Tetrahydrofuran | 209.0 | 209.0 | 209.0 | 209.0 | 209.0 | 209.0 | 209.0 |
| Alnovol SPN452 (1) | 103.5 | 103.5 | 103.5 | 103.5 | 103.5 | 103.5 | 103.5 |
| Dowanol PM (2) | 385.4 | 385.4 | 385.4 | 385.4 | 385.4 | 385.4 | 385.4 |
| Methyl ethyl ketone | 265.9 | 265.9 | 265.9 | 265.9 | 265.9 | 265.9 | 265.9 |
| S0094 (3) | 0.43 | 0.64 | 0.86 | 0.107 | 1.28 | 1.71 | 2.14 |
| Basonyl Blue 640 (4) | 0.53 | 0.53 | 0.53 | 0.53 | 0.53 | 0.53 | 0.53 |
| Tego Glide 410 (5) | 21.35 | 8.50 | 8.50 | 8.50 | 8.50 | 8.50 | 8.50 |
| Tego Wet 265 (5) | 8.53 | 21.55 | 21.55 | 21.55 | 21.55 | 21.55 | 21.55 |
| 2,3,4-trimethoxy | 5.34 | 5.34 | 5.34 | 5.34 | 5.34 | 5.34 | 5.34 |
| cinnamic acid | | | | | | | |

(1) Alnovol SPN452 is a 40.5 wt. % solution of novolac in Dowanol PM (trademark of Clariant).
(2) 1-methoxy-2-propanol from Dow Chemical Company.
(3) S0094 is an IR absorbing cyanine dye trademark of FEW Chemicals. S0094 has the chemical structure IR-1 shown above.
(4) Basonyl Blue 640 is a quaternized triarylmethane dye trademark of BASF.
(5) Tego Wet 265 and Tego Glide 410 are both block-copolymers comprising polysiloxanes, trademarksof Tego Chemie Service GmbH.; 1 wt % solution in Dowanol PM.

Evaluation and Results

The infrared absorption spectra of the coating of each of the above printing plate precursors were measured with a Perkin Elmer Lambda 900 spectrophotometer in mixed reflection mode. The net reflection density of the coating was obtained using a non-coated sample, obtained by washing the coating from the support with methyl ethyl ketone, as a reference. The band width at 80% of the absorption peak was measured as explained above with reference to FIG. 1. The values are given in Table 2 given below (heading “BW80”).

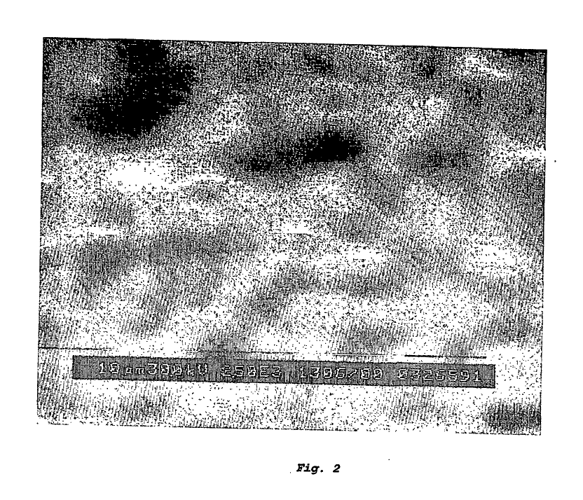

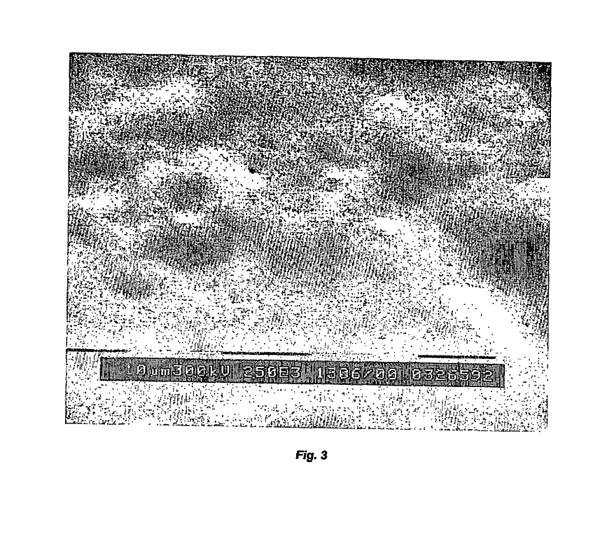

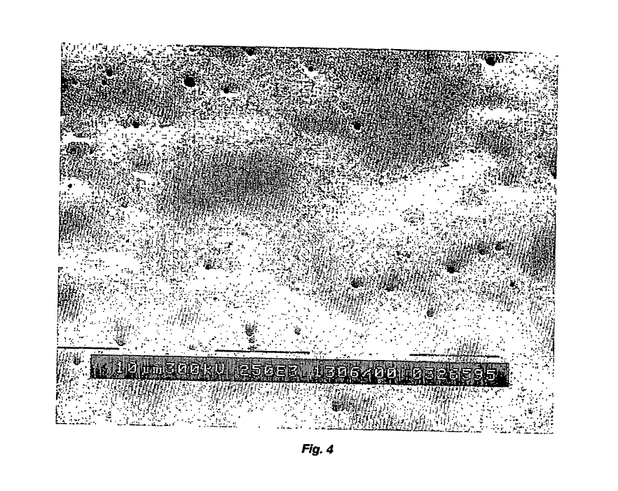

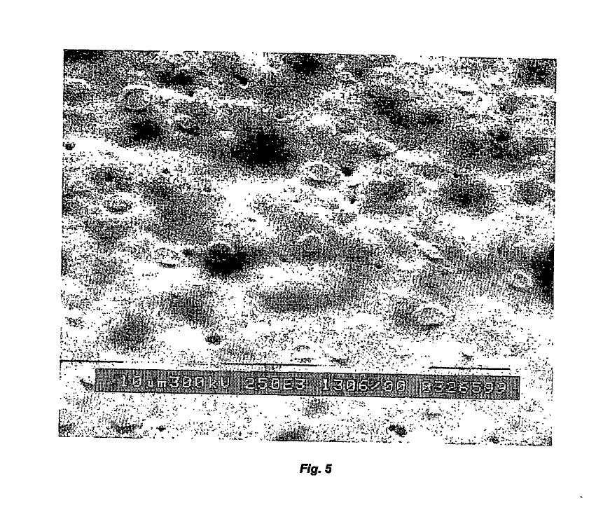

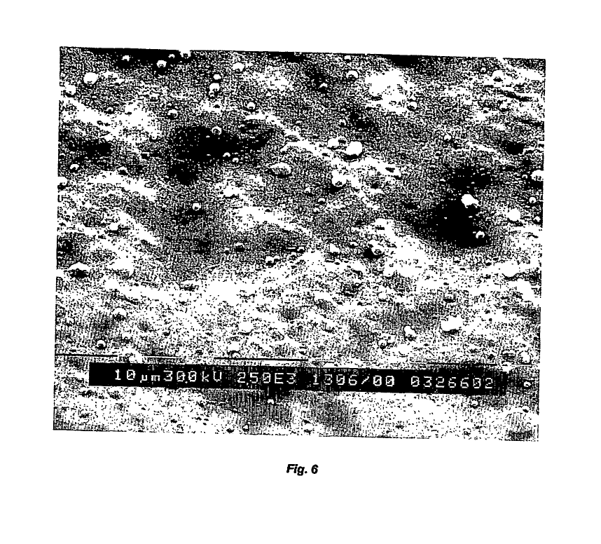

Each of the above printing plate precursors was exposed on a prototype XTD infrared diode laser (830 nm) image-setter at varying power densities as indicated in Table 2 given below. The extent of ablation of the exposed coating was evaluated by comparing the SEM-images obtained of the exposed samples with standard SEM-images (FIGS. 2 to 6). The standard SEM-images (FIGS. 2 to 6) were obtained by exposing a prior art material with the same image-setter as used for Examples 1-7 of this invention. The power density of the exposure increases from FIG. 2 (low value) to FIG. 6 (high value). The visual evaluation of the obtained images was quantified on a scale from 1 to 5 as follows:
“1”=the coating is defect-free and no ablation debris is deposited on the surface of the coating; see FIG. 2.
“2”=onset of damage to the coating (a few small holes are visible) but no ablation debris is observed; see FIG. 3.
“3”=occurrence of a significant amount of holes in the coating but no bubbles nor ablation debris detectable on the surface of the coating; see FIG. 4.
“4”=onset of deposition of ablation debris on the surface of the coating; the coating shows many defects (holes, bubbles); see FIG. 5.
“5”=a significant amount of ablation debris is deposited on the surface of the coating, which is substantially damaged by the exposure; see FIG. 6.

The qualification on the basis of SEM images corresponds well with the visual perception of dust on the imaged plates. Plates which are qualified on the basis of the SEM images as grade “4” or “5”, show a deposition of dust which is perceptible to a human observer and which can be wiped off with a cloth or paper tissue. At grade “4”, the dust is only visible when looking at the reflection of a light source (e.g. a window) on the surface at low angles while a qualification of “5” corresponds to an amount of dust which is very clearly visible on the plate's surface at any angle. Below “3”, no dust is perceivable visually and neither detectable on the SEM images.

TABLE 2
extent of ablation on a scale 1-5 upon
IR exposure at various power densities

| Example | BW80 | Power density (kW/cm²) | | | | | |
|---|---|---|---|---|---|---|---|
| no. | (cm⁻¹) | 145 | 174 | 204 | 233 | 263 | 292 |
| 1 (inv.) | 616 | 1 | 1 | 1 | 2 | 2 | 2 |
| 2 (inv.) | 675 | 1 | 1 | 2 | 2 | 2 | 2 |
| 3 (inv.) | 751 | 2 | 2 | 2 | 3 | 3 | 3 |
| 4 (inv.) | 829 | 2 | 2 | 3 | 3 | 3 | 3 |
| 5 (inv.) | 984 | 2 | 3 | 3 | 3 | 3 | 3 |
| 6 (comp.) | 1586 | 2 | 2 | 2 | 3 | 4 | 4 |
| 7 (comp.) | 1736 | 2 | 2 | 3 | 3 | 4 | 5 |

The results in Table 2 demonstrate that Examples 1-5, which have a band width at 80% of the infrared absorption peak lower than 1000 cm⁻¹, can be exposed at a high power density without the occurrence of ablation debris (grade 1 to 3). Comparative Examples 6 and 7 generate ablation debris (grade 4 or 5) upon infrared exposure above 233 kW/cm².

1. A heat-sensitive lithographic printing plate precursor comprising (i) a metal support having a hydrophilic surface or provided with a hydrophilic layer and (ii) provided thereon a coating comprising an infrared light absorbing dye and a hydrophobic binder which is soluble in an aqueous alkaline developer, wherein the coating has a light absorption spectrum (1) of net reflection density versus wavelength which has an absorption peak (3) at a wavelength λmax in the range between 700 and 1000 nm, wherein said absorption peak has a band width (4), defined as the wave number interval at 80% of the net reflection density at λmax, which is lower than 1000 cm⁻¹.

2. A printing plate precursor according to claim 1 wherein ζmax of the light absorption spectrum of the coating ranges between 700 nm and 890 nm.

3. A printing plate precursor according to claim 1 wherein λmax of the light absorption spectrum of the coating ranges between 700 nm and 850 nm.

4. A printing plate precursor according to claim 1 wherein the coating is capable of dissolving in an aqueous alkaline developer at a lower dissolution rate in areas of the coating which are exposed to infrared light than in unexposed areas.

5. A printing plate precursor according to claim 1 wherein the coating is capable of dissolving in an aqueous alkaline developer at a higher dissolution rate in areas of the coating which are exposed to infrared light than in unexposed areas.

6. A printing plate precursor according to claim 5 wherein the hydrophobic binder is a phenolic resin and wherein the coating further comprises a dissolution inhibitor which is selected from the group consisting of (a) an organic compound comprising an aromatic group and a hydrogen bonding site, (b) a hydrophobic or water-repellent polymer which is insoluble in or impenetrable by the developer, (c) a surfactant comprising a polar group and a hydrophobic group or (d) a block-copolymer comprising a poly- or oligo(alkylene oxide) block and a hydrophobic block.

7. A printing plate precursor according to claim 1 wherein the infrared dye is selected from the group consisting of cyanine dyes, merocyanine dyes, indoaniline dyes, oxonol dyes, pyrilium dyes and squarilium dyes.

8. A printing plate precursor according to claim 1 wherein the infrared dye has the following structure:

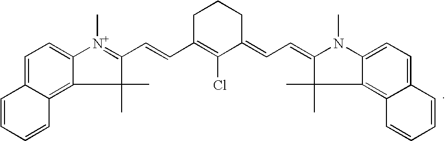

9. A printing plate precursor according to claim 6 wherein the amount of the water-repellent polymer in the coating is between 0.5 and 15 mg/m².

10. A printing plate precursor according to claim 6 wherein the amount of the surfactant in the coating is between 10 and 100 mg/m².

11. A printing plate precursor according to claim 6 wherein the amount of the block-copolymer in the coating is between 0.5 and 25 mg/m².

12. A method of exposing a lithographic printing plate precursor according to claim 1 wherein the coating does not generate ablation upon exposure to laser light having a wavelength in the range of λmax±20 nm and a power density above 233 kW/cm².

13. A printing plate precursor according to claim 2 wherein the coating is capable of dissolving in an aqueous alkaline developer at a lower dissolution rate in areas of the coating which are exposed to infrared light than in unexposed areas.

14. A printing plate precursor according to claim 3 wherein the coating is capable of dissolving in an aqueous alkaline developer at a lower dissolution rate in areas of the coating which are exposed to infrared light than in unexposed areas.

15. A printing plate precursor according to claim 2 wherein the coating is capable of dissolving in an aqueous alkaline developer at a higher dissolution rate in areas of the coating which are exposed to infrared light than in unexposed areas.

16. A printing plate precursor according to claim 3 wherein the coating is capable of dissolving in an aqueous alkaline developer at a higher dissolution rate in areas of the coating which are exposed to infrared light than in unexposed areas.

17. A printing plate precursor according to claim 2 wherein the infrared dye is selected from the group consisting of cyanine dyes, merocyanine dyes, indoaniline dyes, oxonol dyes, pyrilium dyes and squarilium dyes.

18. A printing plate precursor according to claim 3 wherein the infrared dye is selected from the group consisting of cyanine dyes, merocyanine dyes, indoaniline dyes, oxonol dyes, pyrilium dyes and squarilium dyes.

19. A printing plate precursor according to claim 4 wherein the infrared dye is selected from the group consisting of cyanine dyes, merocyanine dyes, indoaniline dyes, oxonol dyes, pyrilium dyes and squarilium dyes.

20. A printing plate precursor according to claim 2 wherein the infrared dye has the following structure:

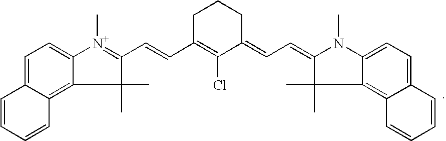

21. A printing plate precursor according to claim 3 wherein the infrared dye has the following structure: [chemical structure]
